(19) United States
(12) Patent Application Publication
(10) Pub. No.: US 2016/0369921 A1
(43) Pub. Date: Dec. 22, 2016

(54) ADAPTER FOR USE IN CONNECTING A SOURCE OF PNEUMATIC PRESSURE TO A HOSE

(71) Applicant: Michael Raymond SEARS, Caddo Mills, TX (US)

(72) Inventor: Michael Raymond SEARS, Caddo Mills, TX (US)

(21) Appl. No.: 15/155,443

(22) Filed: May 16, 2016

Related U.S. Application Data
(60) Provisional application No. 62/231,001, filed on Jun. 22, 2015.

(51) Int. Cl. F16L 33/24

(52) U.S. Cl. CPC F16L 33/24

(57) ABSTRACT

An adapter for use in connecting a source of pneumatic pressure to a hose has a body with an interior passageway, a first set of external threads at one end of the body and a second set of external threads at an opposite end of the body. The first set of external threads has a thread configuration that is different than a thread configuration of the second set of external threads. The body has a wrench-receiving portion located between the first set of external threads and the second set of external threads. The first set of external threads is adapted to connect with a source of pneumatic pressure. The second set of external threads is adapted to connect to the hose. The interior passageway is smooth and unobstructed.

### CROSS-REFERENCE TO RELATED APPLICATIONS

The present application claims priority from U.S. Provisional Patent Application Ser. No. 62/231,001, filed on Jun. 22, 2015, and entitled “One Piece Threaded Adapter”.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to air guns and other sources of pneumatic pressure. The present invention also relates to apparatus for directing a pressurized gas to a location remote from the source of the pressurized gas. More particularly, the present invention relates to adapters that are used to connect a hose with a source of pneumatic pressure.

2. Description of Related Art Including Information Disclosed Under 37 CFR 1.97 and 37 CFR 1.98.

Throughout residential and commercial buildings, there are extensive arrays of drain lines extending throughout the buildings. These drain lines can be in the nature of the drain lines connected to sinks, to bathing facilities to cooking facilities, to awnings and gutters, to sumps to air conditions, and to various items within the house. The intention of the drain lines is to allow water to pass from an exterior or an the interior of the building to another location exterior of the building. In certain circumstances, these drain lines are ultimately connected to the sewer lines associated with the building. In other circumstances, these drain lines simply serve to deliver unwanted water to a location away from the building.

Unfortunately, in many circumstances, these drain lines become clogged with debris. In the instance of drain lines associated with gutters, the drain lines often become clogged with leaf debris. In connection with cooking facilities, the drain lines often become clogged with cooking or washing debris. Whenever the drain line becomes sufficiently clogged with debris, remedial action must be taken so as to remove the clog and to discharge the debris from the drain line. Conventionally, chemicals and/or snaking devices are used so as to remove the debris from the drain line. This is often a very complicated and expensive proceeding. Additionally, it can be rather time consuming for the plumber to install the snaking apparatus for the purpose of debris removal. As such, high pressure gas has been used to remove debris from the drain line.

It is often quite difficult to connect the source of pneumatic pressure to a hose when attempting to direct a pressurized gas into the drain line. In certain circumstances, the end of the hose must be modified so as to conform with the gas outlet of the source of pneumatic pressure. In other circumstances, users will attempt to join the source of pneumatic pressure to the hose by taping the end of the hose to the outlet of the source of pneumatic pressure. Whenever tape is used, there is a possibility of leakage and, as a result, the loss of pneumatic pressure. In other circumstances, the amount of force directed into the hose from that the source of pneumatic pressure becomes too great and will cause the hose to become disconnected from the outlet of the source of pneumatic pressure. In other circumstances, the connection of the hose to the source of pneumatic pressure can become obstructed or have surfaces that interfere with a proper laminar flow of the pressurized gas. As such, need has developed so as to provide a proper adapter which allows a standard HVAC hose to be connected to a source of pneumatic pressure.

In the past, various patents have issued relating to adapters for use in connecting to fluid sources. For example, U.S. Pat. No. 2,710,203, issued on Jun. 7, 1955 to Hunter et al., describes an adapter fitting for hose ends. This fitting is for connecting fluid pressure hoses of unequal sizes. The fitting comprises a sleeve for the end of a smaller hose formed with helical ribbing on the inner wall thereof urging the smaller hose therethrough when turned therein. A one-piece nipple has an externally threaded end portion. The nipple has an opposite end that is adapted to be received within the bore of the smaller hose when the smaller hose is disposed within the sleeve. The nipple is urged through the smaller hose when turned therein. A larger sleeve is used on the end of a larger hose. A nipple is adapted to be received in the bore of the larger hose when the larger hose is disposed in the sleeve.

U.S. Pat. No. 3,586,351, issued on Jun. 22, 1971 to B. Vanderven, shows an adapter fitting for use with a container having a flexible outlet. The adapter fitting has a hollow cylindrical plug integral with a hollow tapered threaded fitting and a hollow cylindrical threaded fitting. The cylindrical plug and tapered threaded fitting of the adapter fitting are inserted within the flexible outlet and a locking nut is screwed thereon so as to hold the flexible outlet in place.

U.S. Pat. No. 4,616,105, issued on Oct. 7, 1986 to R. J. Borsch, shows an adapter fitting for connecting a corrugated flexible conduit to electrical outlet box. The fitting includes a pair of substantially identical, semi-cylindrical cooperating fitting halves. Each fitting half carries a projecting, externally threaded neck portion. The halves are joined by an internally threaded locking ring. A radially inwardly projecting corrugations-engaging rib is provided on the inner side of each fitting half.

U.S. Pat. No. 4,889,369, issued on Dec. 26, 1989 to T. E. Albrecht, shows an adapter fitting made of two parts, namely, a mounting member containing a fluid cavity and a flange member having bolt holes therein. The adapter fitting is designed to enable fluid flow components of the type that can be bolted together and provide sealing at mating surfaces to be used with threaded connections and bolt-on flange connections.

U.S. Pat. No. 5,018,769, issued on May 28, 1991 to T. E. Albrecht, describes an adapter fitting that it is formed of a mounting member containing a fluid cavity and a flange member having bolt holes therein. The adapter fitting enables fluid flow components that are bolted together so as to provide sealing at mating bases that are used with threaded connections and bolt-on flange connections.

U.S. Pat. No. 5,251,938, issued on Oct. 12, 1993 the K. C. Erickson, describes an adapter fitting for sprinkler or drip-type irrigation systems. The adapter pipe fittings provide take-off fittings that snap into offtake connector members of the pipe body. The offtake portion of such a take-off swivel fitting includes a screw-threaded tip backed by a bar for enhancing holding of the attached offtake tubing during the swivel action and for enabling selected take-off swivel fittings to be closed off by screen plugs into the threaded terminal ends thereof.

It is an object of the present invention to provide an adapter that can be used with a variety sources of pneumatic pressure.

It is another object of the present invention to provide an adapter that allows the blowout device to be connected to gauge hoses.

It is another object of the present invention to provide an adapter that can be easily installed.

It is another object the present invention to provide an adapter that avoids turbulence in the flow of pressurized air therethrough.

It is another object of the present invention to provide an adapter that can be simply installed with the use of a wrench.

It is another object of the present invention to provide an adapter that provides for a solid and secure connection between a source of pneumatic pressure and a hose.

It is still another object of the present invention to provide an adapter that effectively creates an air-tight seal between the source of pneumatic pressure and the hose.

These and other objects and advantages of the present invention will become apparent from a reading of the attached specification and appended claims.

### BRIEF SUMMARY OF THE INVENTION

The present invention is an adapter for use in connecting a source of pneumatic pressure to a hose. The adapter comprises a body having an interior passageway, a first set of external threads at one end of the body, and a second set of external threads at an opposite end of the body. The first set of external threads has a thread configuration that is different than a thread configuration of the second set of external threads. The body has a wrench-receiving portion located between the first set of external threads and the second set of external threads. The first set of external threads is adapted to connect with a source of pneumatic pressure. The second set of external threads is adapted to connect with a hose.

In the present invention, the interior passageway is smooth and unobstructed. The body can be formed of brass, steel or a polymer. In the preferred embodiment of the present invention, the body is formed of a brass material. The first set of external threads is a 0.305-32 threads per inch configuration. The second set of external threads are tapered threads. The second set of external threads is, in particular, ¼ inch MPT threads. The wrench-receiving portion has a hexagonal shape. The body has a rounded portion formed between the wrench-receiving portion and the first set of external threads.

The present invention is also an apparatus for introducing a pressurized gas into a drain line. This apparatus comprises a source of pneumatic pressure, a hose, and adapter affixed to an outlet of the source of pneumatic pressure and affixed to an end of the hose, and a gas inlet assembly having a gas inlet opening to an interior of the gas inlet assembly. The hose is connected to the gas inlet. The gas inlet assembly is adapted to be connected to the drain line. The adapter has a configuration similar to that described hereinbefore.

The present invention is also an apparatus for directing a pressurized gas that comprises a source of pneumatic pressure, a hose, and an adapter connected between the source of pneumatic pressure and the hose. The adapter has a configuration similar to that described hereinbefore. A ball valve assembly, similar to that described hereinbefore, can be connected to the hose.

This foregoing Section is intended to describe, with particularity, the preferred embodiment of the present invention. It is understood that modifications to this preferred embodiment can be made within the scope of the present invention. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a side elevational view showing the adapter in accordance with the teachings of the present invention.

FIG. 2 is a plan view showing the adapter of the present invention as used for introducing a pressurized gas into a drain line.

FIG. 3 is a side elevational view showing the adapter of the present invention attached to an air gun.

### DETAILED DESCRIPTION OF THE INVENTION

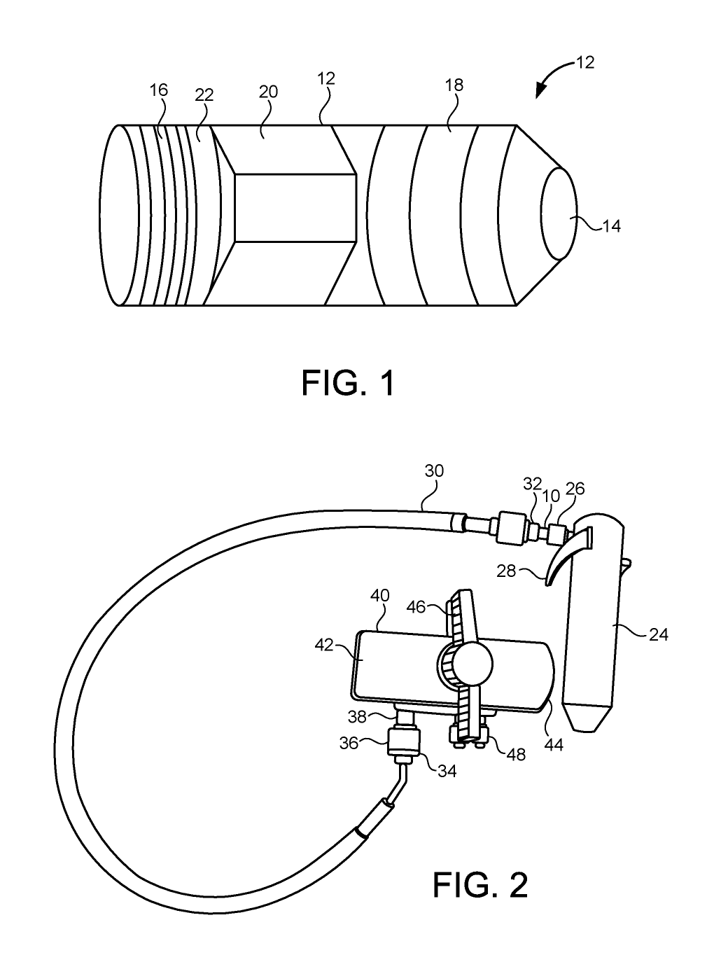

Referring to FIG. 1, there is shown the adapter 10 in accordance with teachings of the present invention. The adapter 10 has a body 12 having an interior passageway 14. The body has a first set of external threads 16 at one end thereof and a second set of external threads 18 at an opposite end thereof. The first set of external threads 16 has a thread configuration that is different than a thread configuration of the second set of external threads 18. The body 12 has a wrench-receiving portion 20 located between the first set of external threads 16 and the second set of external threads 18. The first set of external threads 16 is adapted to connect with a source of pneumatic pressure. The second set of external threads 18 is adapted to connect with a hose.

In the adapter 10 of the present invention, the interior passageway 14 is smooth and unobstructed. In other words, the interior walls of the body 12 are entirely smooth. There are no obstructions, such as in the nature of a Schrader valve, which can interfere with the laminar flow of pressurized gas through the interior passageway 14. The body 12 is formed of material such as brass, steel, polymers, and the like. In the preferred embodiment of the present invention, the body is formed of a brass material.

The first set of external threads has a 0.305-32 threads per inch configuration. As such, this the first set of external threads 16 is particularly adapted to be connected to a source of pneumatic pressure. The second set of external threads 18 are tapered threads. In particular, the second set of external threads 18 is ¼ MPT threads.

The MPT thread of the second set of external threads 18 is a U.S. standard for tapered threads used on threaded pipes and fittings. In contrast to straight threads that are found on a bolt, a tapered thread will pull tight and, therefore, make a fluid-tight seal. The taper on the MPT threads allows them to form a seal when torqued as the flanks of the threads compress against each other, as opposed to parallel/straight thread fittings or compression fittings in which the threads merely hold the pieces together and do not provide the seal. Since the thread body is tapered, a larger diameter keeps compressing into a smaller diameter and finally forms a seal (i.e. no clearance remains between the crests and roots of the threads because of the taper). The taper rate for the MPT threads is 1 inch of diameter in 16 inches of length (i.e. ¾ inch per foot) measured by the change of diameter of the thread over the distance of the thread. The angle between the taper in the center axis of the pipe is tan⁻¹ ( 1/32)=1.7899°. In the present invention, the thread configuration of the second set of external threads 18 is ¼ inch. This means that the thread has a thread density of eighteen per inch. The thread pitch is approximately 0.0555 inches. The thread length is approximately ⅝ of an inch with 11 turns. As such, the special configuration of the threads of the second set of external threads 18 allows the second set of external threads 18 to be connected to a hose in fluid-type relationship.

The first set of external threads 16 fits onto typical carbon dioxide inflator guns and other fittings. The second set of external threads 18 is a flare fitting that fits HBAC standard pressure gauge hose. As such, it is a ¼ inch male MPT fitting. The adapter 10 marries the first set of external threads 16 with the second set of external threads 18. The wrench-receiving portion 20 between the first set of external threads 16 and the second set of external threads 18 is a hexagon which is, preferably, 5 millimeters wide by approximately 11 millimeters in diameter. The rounded portion 22 has approximately a 5 millimeter diameter. The adapter 10 should be formed of material that is thick enough so as to not rupture upon the introduction of a pressurized gas.

The wrench-receiving portion 20 has a hexagonal shape. As such, a standard pipe wrench can be applied onto this wrench-receiving portion so as to effectively rotate the adapter 18 for installation purposes. A rounded portion 22 is formed between the first set of external threads 16 and the wrench-receiving portion 20.

FIG. 2 shows the adapter 10 as applied to a carbon dioxide gun 24. As can be seen, the carbon dioxide gun 24 has an outlet 26 which allows the pressurized gas from within the carbon dioxide gun 28 to pass outwardly therefrom when the trigger 28 is depressed. The first set of external threads 16 of the adapter 10 is received in the outlet 26 of the carbon dioxide gun 24. A hose 30 has one end connected to the second set of external threads 18 of the adapter 10. The inlet 32 of hose 30 has a steel or brass fitting thereon so as to mate with the second set of external threads 18. A rotation of the adapter 10 by applying a wrench to the wrench-receiving portion 20 can cause suitable rotation so as to effectively tighten the inlet end 32 upon the second set of external threads 18 in air-tight relation. The opposite end 34 of the hose 30 is connected by a fitting 36 onto a fluid inlet 38 of a gas inlet assembly 40. As a result of the present invention, an effective sealing relationship is established between the inlet end 32 of the hose 30, the adapter 10, and the outlet 26 of the carbon dioxide gun 24.

The gas inlet assembly 40 is particularly configured for introducing a pressurized gas, such as carbon dioxide, into a drain line. Although, FIG. 2 shows a particular type of blowout assembly, the present invention can be used with a variety of other blowout devices. The gas inlet assembly 40 has a first outlet 42 and a second outlet 44 at opposite ends thereof. A knob 46 extends outwardly of the gas inlet assembly 40. Knob 46 is connected to a valve located within the interior passageway of the gas inlet assembly 40 between the outlet ends 42 and 44. As such, the knob 46 can be rotated so as to block pressurized gas from flowing in the direction toward outlet 44. The pressure from the carbon dioxide gun 24 can be delivered into the drain line (which is connected to the outlet end 42). If it is desired to blow-out the drain line connected to the outlet 44, then the outlet end 34 of the hose 30 can be connected to another inlet 48 of the gas inlet assembly 40. The position of the knob 46 will assure that the pressurized gas will be directed outwardly through the outlet 44 and is prevented from passing to the outlet 42. Each of the inlets 38 and 48 is in the nature of a Schrader valve. As such, the present invention, by achieving a proper seal between the inlet end 32 of the hose 30 and the outlet 26 of the carbon dioxide gun 24 can effectively transmit the entire pressure from the carbon dioxide gun 24 in a continuous laminar flow pattern and without leakage through the adapter 10.

The adapter 10 can be used with a variety of blow-out devices, such as a DRAIN KAT™, a MIGHTY PUMP™, a QB1™, a Jones valve, and all-access valve, a typical airgun, and similar devices. The adapter 10 allows for the blow-out device, such as the carbon dioxide gun 24, and its valves to be hooked into gauge hoses which are hooked to condensate blowout-out devices or valves, as well as other devices in valves and other uses were such an adapter can be utilized. The adapter 10 is the linkage or bridge between the blow-out gauge hose and the pressurized blow-out source device.

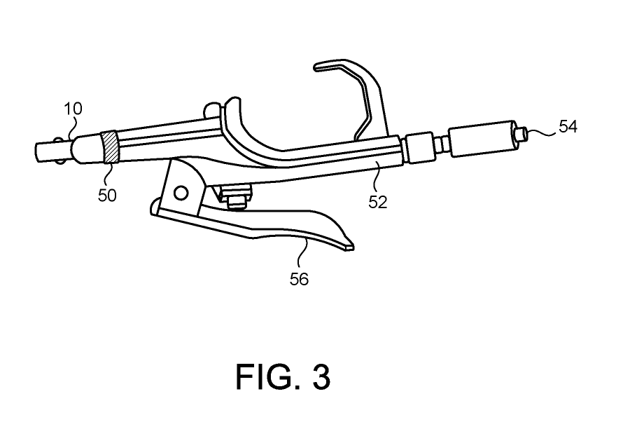

FIG. 3 is an illustration of the adapter 10 as affixed to the outlet 50 of an airgun 52. The airgun 52 has an inlet 54 that is adapted to be connected to a source of pneumatic pressure. These types of pneumatic guns are often using factories where a compressor is connected to the airgun 52 along an extended gas delivery line. As a result, when the trigger 56 is moved toward the airgun 52, the pneumatic pressure is passed outwardly of the outlet 52 and through the interior passageway 14 of the adapter 10. Once again, this airgun 52 can be utilized with the adapter 10 for a wide variety of purposes.

The foregoing disclosure and description of the invention is illustrative and explanatory thereof. Various changes in the details of the illustrated configuration can be made within the scope of the appended claims without departing from the true spirit of the invention. The present invention should only be limited by the following claims and their legal equivalents.

I claim:

1. An adapter for use in connecting a source of pneumatic pressure to a hose, the adapter comprising:
a body having an interior passageway, said body having a first set of external threads at one end thereof and a second set of external threads at an opposite end thereof, said first set of external threads having a thread configuration that is different than a thread configuration of said second set of external threads, said body having a wrench-receiving portion located between said first set of external threads and said second set of external threads, said first set of external threads adapted to connect with a source of pneumatic pressure, said second set of threads adapted to connect with a hose.

2. The adapter of claim 1, said interior passageway being smooth and unobstructed.

3. The adapter of claim 1, said body formed of a material selected from the group consisting of brass, steel and a polymer.

4. The adapter of claim 3, said body being formed of brass.

5. The adapter claim 1, said first set of external threads being 0.305-32 threads per inch.

6. The adapter of claim 1, said second set of external threads being tapered threads.

7. The adapter claim 6, said second set of external threads being ¼ inch MPT threads.

8. The adapter claim 1, said wrench-receiving portion having a hexagonal shape.

9. The apparatus of claim 1, said body having a rounded portion formed between said wrench-receiving portion and said first set of external threads.

10. An apparatus for introducing a pressurized gas into a drain line, the apparatus comprising:
a source of pneumatic pressure;
a hose;
an adapter affixed to an outlet of said source of pneumatic pressure and affixed to an end of said hose; and
a gas inlet assembly having a gas inlet opening to an interior of said gas inlet assembly, said hose connected to said gas inlet, said gas inlet assembly adapted to be connected to the drain line.

11. The apparatus of claim 10, said adapter comprising:
a body having an interior passageway, said body having a first set of external threads at one end thereof and a second set of external threads at an opposite end thereof, said first set of external threads having a thread configuration that is different than a thread configuration of said second set of external threads, said body having a wrench-receiving portion located between said first set of external threads and said second set of external threads, said first set of external threads connected to said source of pneumatic pressure, said second set of external threads connecting to said hose.

12. The apparatus of claim 11, said interior passageway being smooth and unobstructed.

13. The apparatus of claim 11, said first set of external threads being of a 0.035-32 threads/inch thread configuration.

14. The apparatus of claim 11, said second set of external threads being tapered threads.

15. The apparatus claim 14, said second set of external threads being ¼ inch MPT threads.

16. The apparatus of claim 11, said wrench-receiving portion having a hexagonal shape.

17. The apparatus of claim 11, said body having a rounded portion formed between said wrench-receiving portion and said first set of external threads.

18. The apparatus of claim 10, said gas inlet assembly having a body with an outlet, said gas inlet comprising a pipe gas inlet.

19. An apparatus for directing a pressurized gas, the apparatus comprising:
a source of pneumatic pressure;
a hose; and
an adapter connected between said source of pneumatic pressure and said hose, said adapter comprising:
a body having an interior passageway, said body having a first set of external threads at one end thereof and a second set of external threads at an opposite end thereof, said first set of external threads having at that thread configuration that is different than a thread configuration of said second set of external threads, said body having a wrench-receiving portion located between said first set of external threads and said second set of external threads, said first set of external threads connected to said source of pneumatic pressure, said second set of external threads connected to said hose, said first set of external threads being a 0.305-32 threads/threads per inch configuration, said second set of external threads being ¼ inch MPT threads, said wrench-receiving portion having a hexagonal shape.

20. The apparatus of claim 19, further comprising:
a gas inlet assembly having a gas inlet, said hose connected to said gas inlet, said gas inlet assembly adapted to be connected to a drain line.
